(19) United States
(12) Patent Application Publication
(10) Pub. No.: US 2008/0060910 A1
(43) Pub. Date: Mar. 13, 2008

(54) PASSENGER CARRY-ON BAGGING SYSTEM FOR SECURITY CHECKPOINTS

(76) Inventors: Shawn Younkin, (US); Tonya K. Bender, Owego, NY (US)

Correspondence Address: MILES & STOCKBRIDGE PC, 1751 PINNACLE DRIVE, SUITE 500, MCLEAN, VA, 22102-3833, US

(21) Appl. No.: 11/530,378

(22) Filed: Sep. 8, 2006

(51) Int. Cl. B65G 47/46

(52) U.S. Cl. 198/348

(57) ABSTRACT

A threat scanning system may employ disposable flexible baggage containers with a coefficient of friction selected to encourage sliding of the containers past side rails and other baggage. An exemplary system may have a threat scanning machine, a first feeder conveyor having a baggage entrance, a second feeder conveyor substantially parallel to the first feeder conveyor, and a scanner conveyer arranged to receive baggage from the first and second feeder conveyors and to convey baggage to the threat scanning machine, the scanner conveyor having one or more side rails that baggage containers may impact. After baggage is conveyed through the threat scanning machine, the baggage containers may be discarded after a single use.

The present invention relates generally to a threat scanning system such as that disclosed in co-pending U.S. patent application Ser. No. 10/971,021, filed Oct. 25, 2004, incorporated by reference herein, for example.

Threat scanning machines are often employed in locations where safety and security are at issue—for example, at security checkpoints. Transportation facilities, for example, airports, train stations, seaports, and the like, may employ threat scanning machines to detect security threats within passenger or freight baggage. Other facilities, such as office buildings, government buildings, court houses, museums, stadiums, schools, and the like may employ threat scanning machines to detect restricted items being carried by a person seeking entry to the facility. A threat scanning machine, as used herein, refers to any device capable of detecting an object defined as a threat. A threat, as used herein, can be anything that is restricted from being brought aboard a vehicle, into a building, or into an area.

Threat scanning machines may use conveyor systems to transport personal items and rectangular plastic bins containing loose items to the threat scanning machines. Persons entering a security checkpoint place loose items into the plastic bins, and the bins are carried into the threat scanning machine. Often, security personnel carry the used bins from the exit of the threat scanning machine back to the entrance of the checkpoint, where they can be reused. Sometimes passengers must wait while more bins are brought back to the entrance for them to use.

In the past, certain disposable flexible bags were used in airports. For example, awkward items being checked as checked baggage have been placed in bags while the checked items are transported from the check-in counter through checked baggage screening to the luggage hold under an airplane and then from the luggage hold to the checked baggage claim at the destination airport.

Recently, an airport in the United Kingdom provided disposable plastic bags to passengers to contain laptop computers during conveyance through a threat scanning machine. Also recently, an airport in the United States provided small disposable plastic bags, such as Baggies®, for passengers to fill with small personal effects such as coins or keys and to place in a reusable rigid bin for conveyance through a threat scanning machine.

In the present invention, a disposable flexible bag may contain baggage and/or loose items while it is conveyed through a threat scanning machine with multiple lanes, for example. Users can fill the bag while they proceed in the line, and can dispose of the bag when they leave the security area; the bag need not be returned to the entrance for reuse. In relation to various embodiments of the present invention, the term “baggage” includes luggage and large personal effects—such as shoes, jackets and the like—that would not fit in a small bag such as a Baggies® ziplock bag.

In an exemplary embodiment of the bagging system, the bag may have at least four flexible sides and an open end and may be collapsible for easy storage and distribution. The flexible sides may also be self-supporting for ease of filling the bag. In another exemplary embodiment of the present invention, the bag has a means to close and seal an opening, and has printing on the exterior with instructions, restrictions, and/or advertising. In yet another exemplary embodiment of the present invention, the bag has a means for associating the bag with the user. The material of the bag may cooperate with the conveyor system so that it can be handled by the automation without becoming jammed or damaged. For example, the bag may be constructed of a material having a coefficient of friction selected to slide past an impact point of a side rail in a multiple conveyor system, and to slide past another piece of luggage that may be contained in another bag and conveyed by a different converging conveyor of the multiple conveyor system. Further, the bag may be reinforced with rigid corners or edges adapted to assist the bag to slide past an impact point of a side rail in a multiple conveyor system, and to slide past another piece of luggage that may be contained in another bag and conveyed by a different converging conveyor of the multiple conveyor system.

### BRIEF DESCRIPTION OF THE DRAWINGS

FIG. 1 shows one embodiment of the baggage handling system with a first and second entrance and corresponding feeder conveyors, a scanner conveyor, a threat scanning machine, a first and second exit, a supply of baggage containers near each of the first and second entrances, and a trash receptacle near each of the first and second exits.

FIG. 2 shows one embodiment of the flexible baggage container with five flexible sides, for example, and an opening in the top.

FIG. 3 shows another embodiment of the flexible baggage container with three surfaces, a closing feature, identification and instruction or advertising information printed on it, and integrated scanning features.

FIG. 4 shows another embodiment of the flexible baggage container with four flexible side panels, a reinforced bottom, four corner flanges, and an opening in the top.

### DETAILED DESCRIPTION

While the exemplary embodiments illustrated herein may show the various features of the present invention, it will be understood that the features disclosed herein can be combined variously to achieve the objectives of the present invention.

A baggage handling system of the present invention may have a first and second entrance point along with corresponding feeder conveyors, a scanner conveyor with side rails, a threat scanning machine, a first and second exit, a supply of baggage containers near each of the first and second entrances, and a trash receptacle near each of the first and second exits.

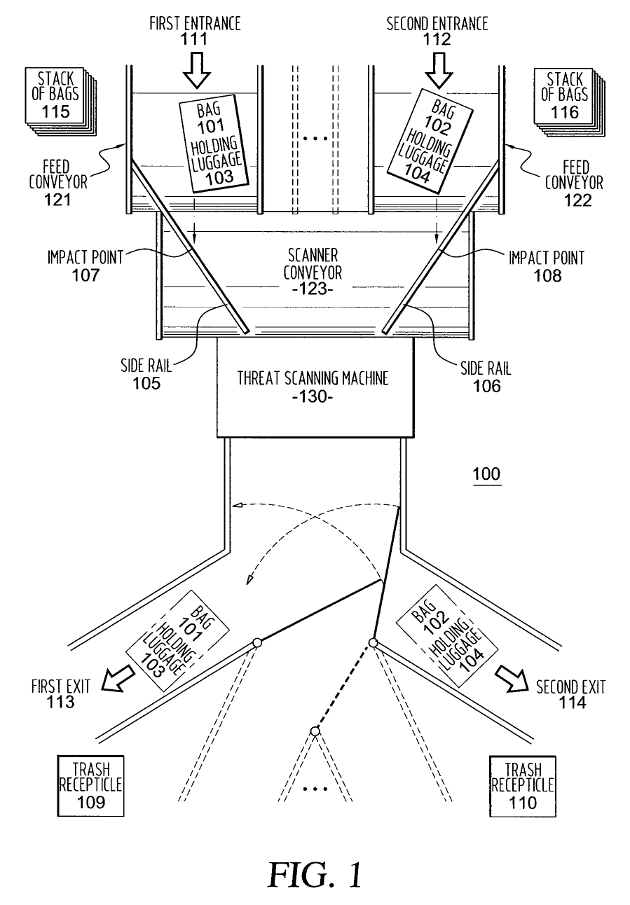

Turning to FIG. 1, an embodiment of the baggage handling system [100] is shown where users may select a baggage container [101, 102], or bag, from a supply of bags [115, 116] located at either of a first and second entrance [111, 112]. Users can then place their luggage [103, 104] into the bag and deposit the bag onto a feeder conveyor [121, 122] corresponding to either the first or second entrance. Deposited bags are carried by the feeder conveyors onto a single scanner conveyor [123], where they impact one or more side rails [105, 106], are thereby converged, and are carried through a threat scanning machine [130]. As the bags exit the threat scanning machine, they are routed toward a corresponding first or second exit [113, 114] where users may retrieve the bag(s) holding their luggage. Once the users have retrieved their bags, they may remove their luggage and deposit the used bags into a trash receptacle [109, 110] located at either of the first or second exit. Alternatively, users may elect to leave their luggage in the bag and carry the bag with them.

The bagging system of the present invention is constructed of flexible materials. The bag material can be designed to produce at least one surface and designed to create an interior storage space. At least one of these surfaces has an opening, through which the user can place items into the baggage container. For example, the baggage container could have one surface, with an opening, that is substantially spherical in shape. The baggage container could alternatively be designed with five surfaces—a bottom, four sides, and an opening at the top—so that the container stands upright on a conveyor. Alternatively, the baggage container could be designed with three surfaces—two side surfaces, with one surface along the bottom—that create an envelope-type configuration.

Regardless of the specific design of the baggage container, or bag, at least one of the surfaces is produced of substantially flexible materials. This allows the bag to be collapsed and opened. It would also provide for lighter bag weight and take up less space than a rigid bin structure. Non-limiting examples of such materials include: paper, cellophane, polyethylene, polyester, nylon, polyvinylidene chloride, saran films, cloth, neoprene, or Kevlar composite paper. These bags are distributed to users as they enter the security area. Users can fill the bag while they proceed in the line and dispose of the bag when they leave the security area, without having to transport them back to the entrance to be reused.

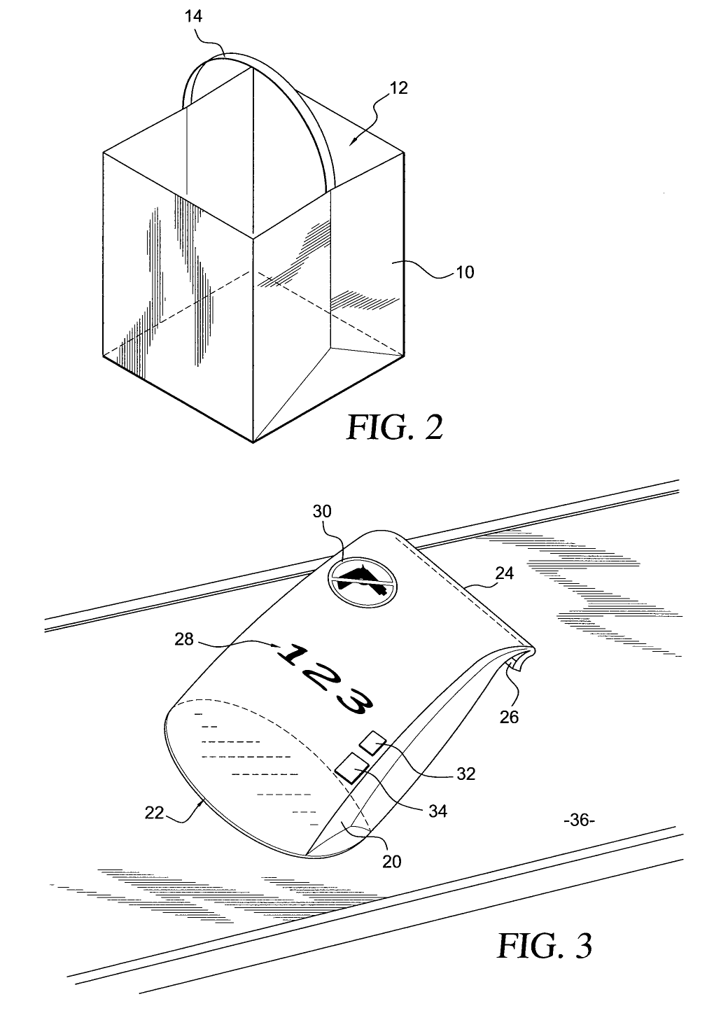

Turning to FIG. 2, the baggage container [10] is shown as a five-sided bag with an open top, creating an interior space [12]. The sides create an enclosed space that would substantially contain items placed into the bag. The bag can be designed to contain most items, but does not necessarily need to completely contain all items. For example, a jacket may be substantially contained, but project from the top of the bag. The bag as shown can be collapsible to a flat position. It is also possible for the bag to remain in an open shape, or to have an integral frame to hold its shape. Any integral frame could also be collapsible for convenience. The bag material could be opaque or, optionally, transparent or translucent, which would allow security personnel to see what is inside the bag. Further, the bag can be designed to have one or more straps or handles [14]. Such straps or handles may facilitate filling the bag while encumbered with other baggage and may include, for example, shoulder straps or features that may enable the bag to stand open and upright while being filled.

Turning to FIG. 3, this exemplary embodiment of the baggage container shows a bag with three surfaces: a bottom surface [22] and two sides sealed on their edges. This embodiment has a closure [24] that closes the top opening. The closure [24] further includes optional sealing means [26]. For example, the sealing could be adhesive tape with a removable cover strip, but could also be other means, such as: a zipper, snaps, Velcro, a plastic ziplock strip, drawstring, or other means.

This embodiment can further be designed to operate in conjunction with the threat scanning system conveyor [36]. It is desirable to design a bagging system that resists tipping, spilling, or snagging on the conveyor system. Among other features, the bottom surface [22] could be produced from a stiff material to hold the bag upright. The materials of the bag and the conveyor surface could be matched such that the coefficient of friction between the surfaces is high enough to resist bag slippage. Further, the aspect ratio of the bag, i.e. the ratio of the height to the width, could be designed to reduce the possibility of tipping. A variety of bag shapes and sizes could be provided to accommodate different items and baggage that users take through security. Also, sealing the bag, as described above, would help to keep items contained in the bag in the event the bag tips over on the conveyor. The bag could also be designed to minimize the potential for jamming in the multi-lane conveyor system. For instance, wider, stiffened edges (e.g., cardboard) could resist getting caught between conveyors and other multi-lane diverting subsystems such as slide arms.

A further feature that could optionally be added to the bagging system would detect if the bag were removed from the security area without being scanned. One means for achieving this would be to attach a passive, semi-passive, or active radio frequency identification (RFID) [32] to the bag. In another embodiment, the bagging system could work in conjunction with the threat scanning machine to demagnetize or reprogram the RFID so that it could be removed from the area without setting off an alarm, if the user wanted to keep their items in the bag after leaving the security area.

In yet another exemplary embodiment of the invention, the bagging system could include a means for examining the items placed into the bag. In one embodiment, the means could be a sensor [34] attached to or embedded in the bag that inspects the items placed in the bag for restricted materials. These sensors could be selected from a set of sensors, including color changing materials, that would sense one or more of: biological, chemical, biohazardous, or radioactive materials. This could also be accomplished with one or more microsensors, for example, a Surface Acoustic Wave (SAW) sensor or a microfluidic-based or Micro Electro-Mechanical Systems (MEMS) sensor. In yet another embodiment, the material of the bag surface could have visualization methods embedded into it, non-limiting examples including ultrasonic or X-ray visualization means. For example, thin and flexible ultrasonic visualization fabric materials used in other applications, including cancer screening, could be integrated into the bagging system and used as the bag material. Either the sensors or the visualization means could then remotely transmit the results of the inspection screening or the visualization images to the security screeners. The results could be visible via manual inspection as well.

A further optional feature of the baggage handling system would provide a means for associating a baggage container with the specific passenger using it. This feature could be used to allow the passenger to find his particular bag among all the bags being screened. It could also be used to allow security personnel to identify the owner of a bag after it has been screened. One way of accomplishing this feature would be to print an alphanumeric code [28] on the exterior of the bag. This code could be associated with corresponding owner identity information such as that of a boarding pass or driver's license, a reservation number, picture, or biometric data. Another way would be to use a colored material for at least some portion of the bag, including an opaque or translucent color. Other options include: using a bar code, passive RFID tag, or active RFID tag programmable with the passenger's identity, or a ticket or tear-off bag tag that the passenger carries with him throughout the screening process.

Yet another optional feature of the bagging system would be to add printed information [30] to the exterior of the bag. The information could be one or more of: instructions for using the bag, restrictions on what can be placed into the bag and icons that represent the above information, as well as advertising names, logos, pictures and slogans. These features could further be used with any type of baggage container, including the plastic bins typically being used in current security checkpoints.

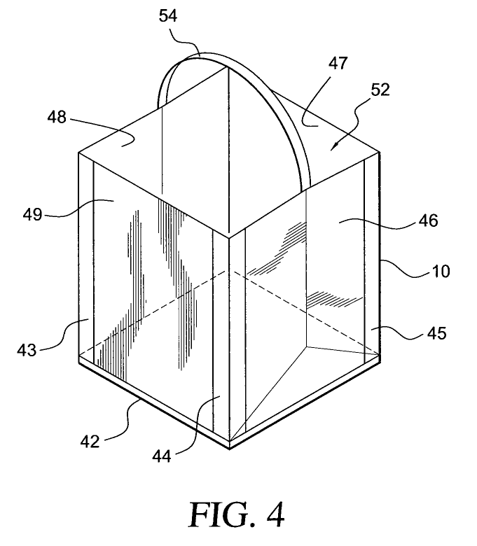

Turning to FIG. 4, this exemplary embodiment of the baggage container shows a five-sided bag with an open top, creating an interior space [52]. The bag as shown has corner flanges [43-45] that could increase the rigidity of the bag and may help to minimize the potential for jamming as the bag is conveyed through multiple lane diverting and transporting subsystems. The flexible side panels [46-49] extend between the relatively rigid corner flanges and create an enclosed space that would substantially contain items placed into the bag. The bag could have a reinforced bottom [42] that could help the bag to remain in an upright position as it is conveyed through a threat scanning machine. The bag can be designed to contain most items, but does not necessarily need to completely contain all items. For example, a jacket may be substantially contained, but project from the top of the bag. The bag material could be opaque or, optionally, transparent or translucent, which would allow security personnel to see what is inside the bag. Further, the bag can be designed to have one or more straps or handles [54]. Such straps or handles may facilitate filling the bag while encumbered with other baggage and may include, for example, shoulder straps or other support features. While the corner flange is preferably angled, e.g. at ninety degrees, it may instead be rounded or flat.

While the baggage container is preferably disposable, it may instead be re-circulated to and reused at an entrance to a threat scanning machine after a first conveyance through the threat scanning machine.

Any of the above features could be combined into an embodiment of the baggage handling system. The baggage handling system would be implemented by providing baggage containers to the users as they enter the security screening area, or at any earlier point in the screening process. For instance, the baggage containers could be made available in associated kiosks or at on-site or off-site retail shops, so the containers could be filled during a time most convenient for the user. The users would put their items into a bag, choose whether or not to close the bag, if such a feature is provided in that embodiment, and then deposit the bag with the threat scanning machine. The users could pick up their bags after screening, and then exit the security area. At the exit, the users could remove their items and dispose of the bag. Alternatively, the bags could be collected and taken to the entrance of the security area for reuse. As another alternative, the users could elect to take the bags with them; this would facilitate clearing the exit lanes for subsequent users. As a further alternative, a variety of bag sizes and shapes could be used for different items, or the bags could be used in conjunction with other types of baggage containers, such as plastic bins.

It is, therefore, apparent that there is provided in accordance with the present invention, systems and methods for managing the delivery of items to threat scanning machines. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

What is claimed is:

1. A method of screening passenger baggage comprising:
placing a disposable container at an entrance to a threat scanning machine located at a security checkpoint, the container being adapted for receiving an item of baggage and for containing the item during conveyance through the threat scanning machine, the container comprising:
a bottom;
a plurality of flexible side panels, the flexible side panels meeting at at least one corner; and
a relatively rigid flange secured at the corner of the flexible side panels, the flange extending from the bottom to an open top;
making the container available to a passenger passing through the checkpoint;
conveying the container containing the item through the threat scanning machine while the container rests directly on a moving conveyor belt of the threat scanning machine; and
discarding the container upon a single conveyance through the threat scanning machine.

2. The method of claim 1, wherein the threat scanning machine is fed by a plurality of conveyor belts arranged in multiple separate lanes, each belt conveying flexible, disposable containers containing items of baggage.

3. The method of claim 1 wherein the bottom is rigid.

4. The method of claim 1 wherein the flange is angled.

5. A baggage handling system comprising:
a threat scanning machine;
a scanner conveyer belt arranged to convey baggage through the threat scanning machine from an entrance to an exit;
a plurality of baggage containers provided at a first location preceding the entrance, each of the baggage containers comprising:
a bottom;
a plurality of flexible side panels, the flexible side panels meeting at at least one corner; and
a relatively rigid flange secured at the corner of the flexible side panels, the flange extending from the bottom to an open top.

6. The system of claim 5, further comprising a plurality of feeder conveyor belts forming multiple separate lanes, each belt feeding conveyed items to the scanner conveyor belt.

7. The system of claim 6, wherein the scanner conveyor belt includes associated subsystems for diverting and transporting the baggage through the multiple lanes of the system and through the threat scanning machine from the entrance to the exit.

8. The system of claim 5, wherein the conveyor belt includes associated subsystems for diverting and transporting the baggage through the threat scanning machine from the entrance to the exit.

9. The system of claim 5 wherein the bottom is rigid.

10. The system of claim 5 wherein the containers are disposable.

11. The system of claim 5 wherein the flange is angled.

12. The system of claim 5 further comprising a trash receptacle designed and dimensioned to receive the containers, the trash receptacle being placed at a second location following the exit.

13. A baggage handling system comprising:
a threat scanning machine;
a first feeder conveyor having a first entrance;
a second feeder conveyor substantially parallel to the first feeder conveyor, the second feeder having a second entrance;
a scanner conveyer arranged to receive baggage from the first and second feeder conveyors and to convey baggage through the threat scanning machine, the scanner conveyor having a first side rail with a first impact point and a second side rail with a second impact point;
a plurality of flexible baggage containers located near the first entrance and provided to passengers using the first entrance; and
a plurality of flexible baggage containers located near the second entrance and provided to passengers using the second entrance,
wherein the flexible baggage containers have a coefficient of friction with the first and second side rails sufficient to encourage sliding of the containers past the impact points, and
wherein the feeder conveyors form multiple separate lanes, each conveyor feeding conveyed items to the scanner conveyor.

14. The system of claim 13, wherein each of the flexible baggage containers comprise:
a bottom;
a plurality of flexible side panels, the flexible side panels meeting at at least one corner; and
a relatively rigid flange secured at the corner of the flexible side panels, the flange extending from the bottom to a top.

15. The system of claim 14, wherein the edges of the baggage containers are adapted to minimize the potential for jamming in the multiple lanes.

16. The system of claim 14 wherein the bottom is rigid.

17. The system of claim 14 wherein the flange is angled.

18. The system of claim 13, wherein the flexible baggage containers have a coefficient of friction selected to encourage sliding of the containers past other luggage.

19. The system of claim 13, wherein the scanner conveyor includes associated subsystems for diverting and transporting the baggage through the multiple lanes of the system and through the threat scanning machine.

20. The system of claim 19, wherein the edges of the baggage containers are adapted to minimize the potential for jamming in the multiple lane diverting and transporting subsystems.
